(19) United States
(12) Patent Application Publication
(10) Pub. No.: US 2015/0007942 A1
(43) Pub. Date: Jan. 8, 2015

(54) HEATING SYSTEM PRIOR TO THE BINDING OF CORRUGATE PAPER RAW MATERIALS

(71) Applicant: Wei-Hung HUNG, New Taipei City (TW)

(72) Inventor: Wei-Hung HUNG, New Taipei City (TW)

(21) Appl. No.: 13/934,866

(22) Filed: Jul. 3, 2013

(51) Int. Cl. B31F 5/00

(52) U.S. Cl. CPC B31F 5/00
USPC 156/378

(57) ABSTRACT

A heating system prior to the binding of corrugate paper raw materials is applied in the process for manufacturing corrugated cardboard. At least one infrared heating device(s), at least one temperature sensor(s) and a laminator are assembled in the equipment line of the present invention. The corrugate paper raw materials to be bounded can be heated up to raise the temperatures respectively by the light radiation heat produced from the infrared heating device(s). The temperature sensor(s) is electrically connected with the infrared heating device(s) so that the temperatures of the corrugated paper raw materials irradiated by the light radiation heat can be detected and then the temperature can be adjusted quickly and precisely to meet required working temperature. When the required working temperature of the paper raw materials is reached, the binding operation of the corrugate paper raw materials to form corrugated cardboard can be accomplished by the laminator.

### BACKGROUND OF INVENTION

1. Field of the Invention

The present invention relates to a heating system prior to the binding of corrugate paper raw materials, which is applied in the process for manufacturing corrugated cardboard, more particularly to a heating system prior to the binding of corrugate paper raw materials in which infrared heating devices are employed to cooperate with temperature sensors respectively so as to adjust the working temperature of the corrugate paper raw materials to temperature suitable for binding, and a laminator is utilized to accomplish the manufacturing of corrugated cardboard.

2. Brief Description of the Prior Art

Referring to FIG. 1, corrugated paper manufacturing equipment 10 is mainly formed by a plurality of corrugate forming wheels 101, a paper guiding wheel 102, a balancing windlass 103. As shown in the figure, the corrugate forming wheels (101,101′) are formed with a plurality of corrugate forming sections (1011,1011′) on their surfaces, through which a first paper raw material 11 is rolled into corrugate shape to form a core layer 12. When passing through the corrugate forming wheel 101′, the core layer 12 of the first paper raw material 11 has its one surface 121 conducted with gumming operation by a first gumming device 105 so as to form a glue layer. This glue layer can be bound with the core layer 12 after the paper guiding wheel 102 delivers a second paper raw material 13, so that a bottom layer 13′ is formed after the second paper raw material 13 is bound to the core layer 12. When the binding operation in the bottom layer 13′ is accomplished, the other surface 122 of the core layer 12 is conducted with gumming operation by a second gumming device 106 so as to form another glue layer. The another glue layer is then bound with a third paper raw material 14 delivered by the paper guiding wheel 102′, so that a face layer 14′ is formed after the third paper raw material 14 is bound on the surface 122 of the core layer 12. The core layer 12 with the bottom layer 13′ and the face layer 14′ bound thereon is further introduced into a laminator 107 in which the binding among the core layer 12, the bottom layer 13′ and the face layer 14′ can be made tighter.

Bringing forward from FIG. 1, in order to facilitate the binding operation between paper raw materials, a heating devices is provided on the delivery track of each paper raw material for heating up each paper raw material prior to the binding operation thereof, so that the glue layer coated on the surface of each paper raw material is prone to stick.

Referring to FIG. 2, a corrugated cardboard heating device 20 for corrugated cardboard binding mainly comprises a plurality of heating devices 21 formed by steel, each of which is connected to a boiler 22. In the boiler 22, steam is produced by combustion of kerosene or gas and then delivered to the interiors of the heating devices 21 through the connection of the boiler 22 to the heating devices 21 so as to heat up the surfaces of the heating devices 21. The corrugate paper raw materials 23 passing over heating devices 21 are heated respectively thereby and then undergoes shaping, setting, delivery operations so as to form a corrugated cardboard. However, as the conventional heating device 21 is made of metal material and is in hollow shape with high temperature steam introduced therein so as to produce high temperature on the surface thereof. It is found some disadvantages exist in this conventional device:

(1) The whole heating device 21 is in high temperature when heated by steam. After passage of the corrugate paper raw materials 23 over the heating devices 21, the temperature of the heating devices 21 rapidly decline so that the overall heating devices 21 begin to present the phenomena of temperature unevenness. After a period of use, the heating devices 21 will gradually generate cold shrinkage and thermal expansion resulted from temperature unevenness, and resulting in deformation of the heating devices 21.

(2) Temperature adjustment and control is difficult in the heating devices 21. Energy loss is relatively large, resulting in waste of resource.

(3) The cost of building a steam equipment is high, requiring quite large construction area including installation of steam equipment, roller, boiler.

(4) Fuel used is combustible oil (gasoline, diesel) which is environmentally unfriendly.

(5) Each item of equipment must meet pressure safety regulation, otherwise industrial safety accident is easily occurred.

### SUMMARY OF INVENTION

The main object of the present invention is to provide a heating system prior to the binding of corrugate paper raw materials, which has high safety and the heating temperature can be automatically adjusted and controlled.

This invention mainly has at least one set(s) of infrared heating device respectively provided on the track(s) of corrugate paper raw materials prior to the binding operation. Each infrared heating device has a plurality of infrared lamps which produce light radiation heat promptly after activation. The light radiation heat thus produced is irradiated directly on the corrugate paper raw material passing over so as to heat up the corrugate paper raw material quickly to required working temperature suitable for subsequent binding operation. When heated by the infrared heating device, the major body of each corrugate paper raw material is detected by a temperature sensor so as to know whether the corrugate paper raw material reaches suitable working temperature or not. If required working temperature is not yet reached, the temperature sensor drives the infrared heating device to be heated up so as to irradiate more heat on the corrugate paper raw material to raise its working temperature, and then the corrugate paper raw material reaching required working temperature is conducted with binding operation and then delivered to a laminator for further pressing. In this manner, the heating temperature can be automatically adjusted so as to reach required working temperature of the corrugate paper raw material. Moreover, bulky heat-up device (such as boiler) is not needed so that equipment investment and set-up space can be significantly reduced.

### BRIEF DESCRIPTION OF ACCOMPANYING DRAWINGS

FIG. 1 is a schematic view of the flow chart for manufacturing conventional corrugate paper raw material.

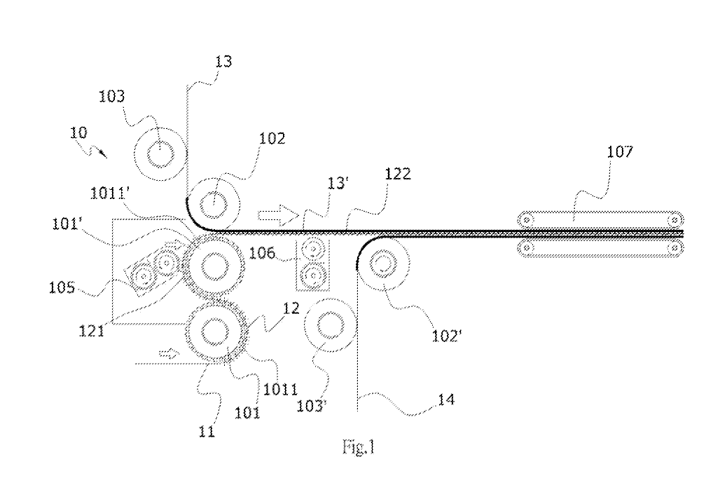

FIG. 2 is a schematic view of conventional heating device for corrugated cardboard binding.

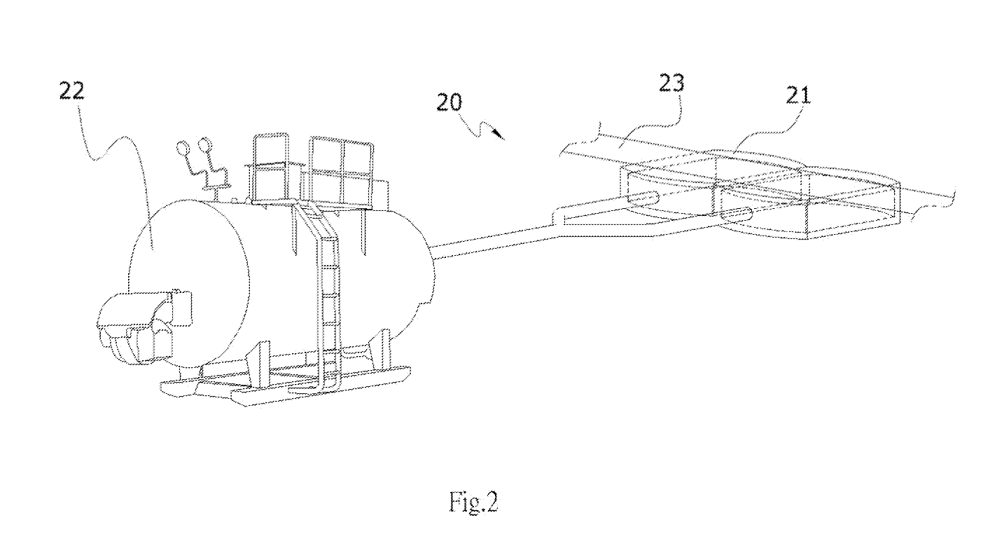

FIG. 3 is a schematic view of the constitution of members of the present invention.

FIG. 4 is a schematic view (I) of the implementation of the present invention.

FIG. 5 is a schematic view (II) of the implementation of the present invention.

FIG. 6 is another embodiment (I) of the present invention.

FIG. 7 is yet another embodiment (II) of the present invention.

### DETAILED DESCRIPTION OF PREFERRED EMBODIMENTS

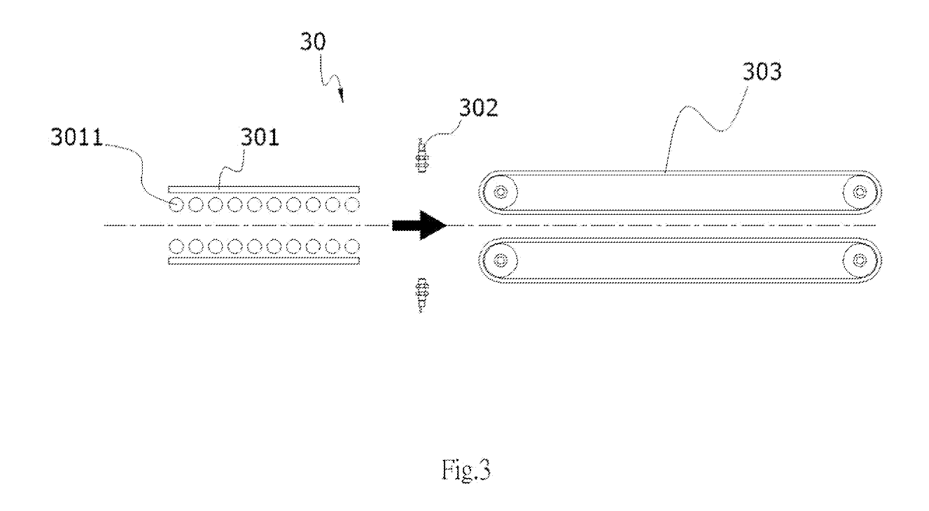

Referring to FIG. 3, the heating system 30 prior to the binding of corrugated paper raw materials is mainly installed in the manufacturing process prior to the binding of a corrugated paper raw material 31 (not shown). The heating system 30 is constituted by at least an infrared heating device(s) 301, at least one temperature sensor(s) 302 and a laminator 303. The infrared heating device 301 is provided on the delivery track of the corrugate paper raw material 31 and is formed by a plurality of infrared lamps 3011. When each infrared lamp 3011 is activated, the light source produced can generate light radiation heat which is irradiated on the corrugate paper raw material 31 for raising the overall temperature of the corrugate paper raw material 31. The temperature sensor 302 in normal state is assembled at one end of the infrared heating device 301 and is electrically connected therewith. After the corrugate paper raw material 31 is irradiated by the infrared heating device 301, the temperature sensor 302 can detect directly whether the temperature of the major body of the corrugated paper raw material 31 reaches required working temperature or not. The laminator 303, which is installed behind the temperature sensor 302, conducts binding operation for the corrugated paper raw material 31 to form a corrugated cardboard.

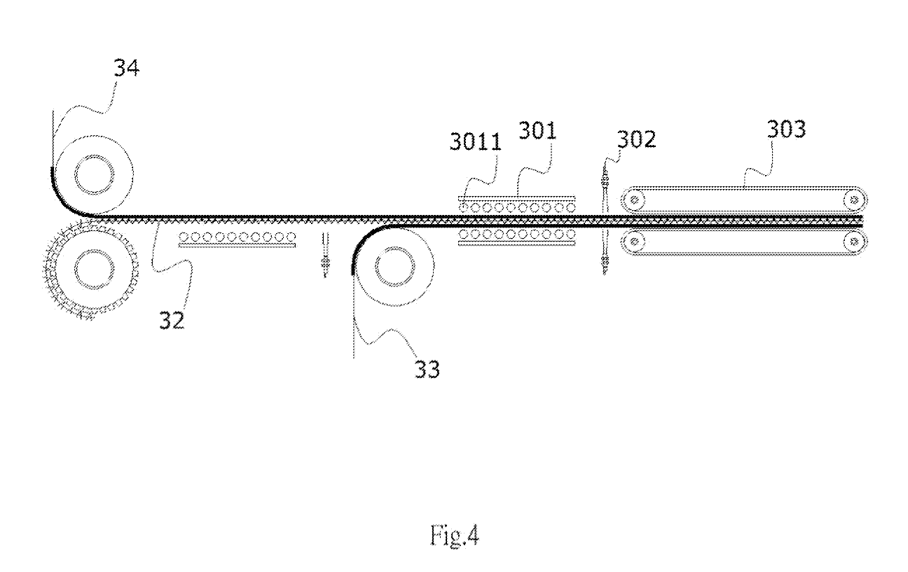

Referring to FIG. 4, the quantities of the infrared heating device 301 and the temperature sensor 302 can be either increased or decreased according to demand. As shown in the figure, paper raw materials such as the core layer 32, the bottom layer 33 and the face layer 34, after completion through front-end processes, are further to be conducted with binding operation. In this case, an infrared heating device 301 and a temperature sensor 302 are provided on the respective delivery track of the core layer 32, the bottom layer 33 and the face layer 34 in advance. The temperature sensor 302 is installed at one end of the infrared heating device 301 so as to detect the temperature of each paper raw material (the core layer 32, the bottom layer 33 and the face layer 34). When each paper raw material (the core layer 32, the bottom layer 33 and the face layer 34) is to be conducted with binding operation, it firstly passes through corresponding infrared heating device 301 and is irradiated by the light radiation heat emitted from the infrared heating device 301, so that the major body of each paper raw material (the core layer 32, the bottom layer 33 and the face layer 34) is heated up. Referring to present figure again, after irradiation by the light radiation heat from the infrared heating device 301, the practical temperature of each paper raw material is detected by the temperature sensor 302 to see if it reaches predetermined working temperature. As the temperature sensor 302 and the infrared heating device 301 are electrically connected with each other, the illumination power of the plurality of lamps of the infrared heating device 301 can be raised to emit light radiation heat with higher temperature, so that the paper raw materials (the core layer 32, the bottom layer 33 and the face layer 34) not yet reach required working temperature can be irradiated by light radiation heat with higher intensity so as to reach the working temperature desired by users. Thus, the working temperature of the paper raw material (the core layer 32, the bottom layer 33 and the face layer 34) can be effectively adjusted to reach the temperature suitable for binding by the cooperation of the infrared heating device 301 and the temperature sensor 302, and the paper raw material (the core layer 32, the bottom layer 33 and the face layer 34) can be bound together by the laminator 303 to accomplish the manufacturing of the corrugated cardboard.

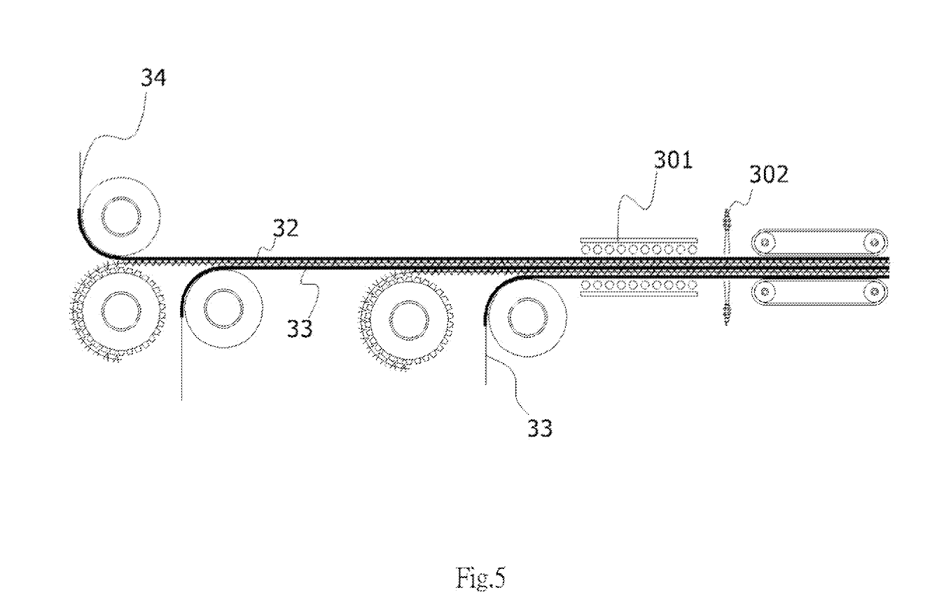

Referring to FIG. 5, the corrugated cardboard can be formed by several layers of paper raw material, for example, the corrugated cardboard as shown in this figure is formed by the adhesion of multilayer containing the core layer 32, the bottom layer 33 and the face layer 34, and the infrared heating device 301 and the temperature sensor 302 can be installed on the paper feeding track of each paper raw material, so as to allow each paper raw material reaching its required working temperature.

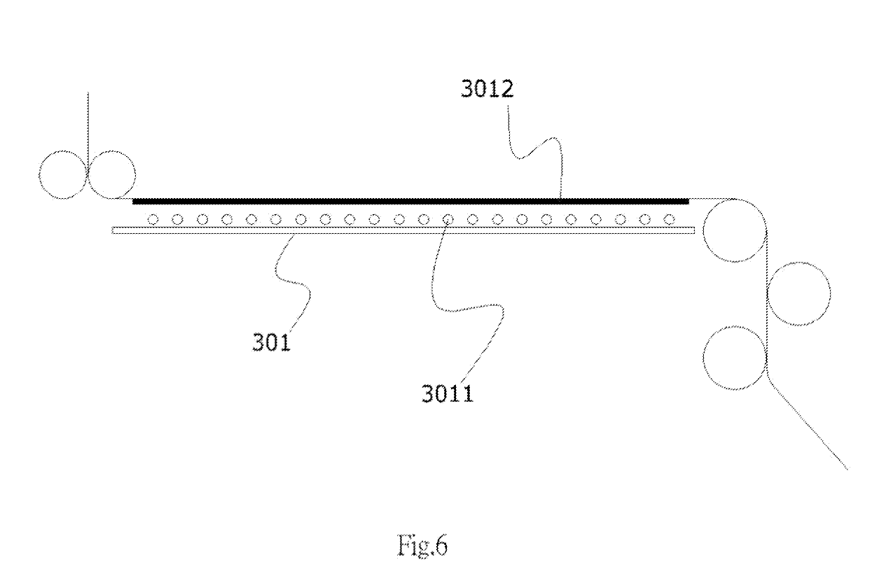

Referring to FIG. 6, a flat plate body 3012 can further be provided over the plural infrared lamps 3011 of the infrared heating device 301. The flat plate body 3012 has a bearing plane 3013 on its surface for the pass-through of each paper raw material. When the infrared lamps 3011 is activated, the light radiation heat produced is transmitted through the flat plate body 3012 and irradiated directly on the paper raw material passing through the bearing plane 3013 of the flat plate body 3012, and the paper raw material absorbs the light radiation heat so as to be heated up to the required working temperature which can facilitate subsequent setting and binding operations. Further, the flat plate body 3012 in normal state is provided over the infrared lamps 3011, which can provide the function of bearing the paper raw material when the paper raw material has low tension in the delivery process thereof.

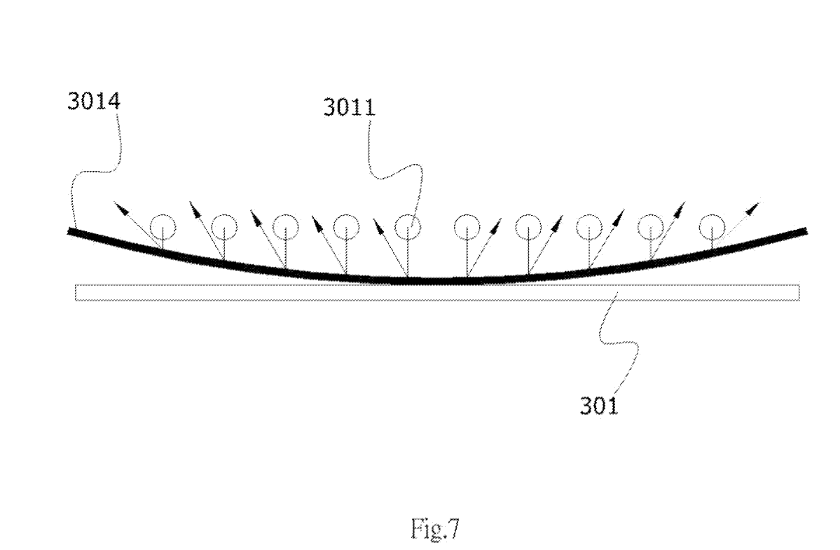

Referring to FIG. 7, a reflector 3014 is provided at the bottom of the infrared lamps 3011 of the infrared heating device 301. As the light radiation produced from the infrared lamps 3011 is diffused radially, the light radiation can be collimated upward by the reflection from the reflector 3014 so that the light radiation generated by the infrared lamps 3011 can be concentrated for heating up the paper raw material more quickly.

According to the implementation based on foregoing of the present invention, the paper raw materials are heated up quickly by the respective infrared heating devices so as to facilitate the above operations of the process, and the temperature sensors are employed to detect whether the paper raw materials thus heated reach required working temperature or not. Then the temperatures generated by the infrared heating devices are adjusted according to the detected results of the temperature sensors, so that the paper raw materials can be delivered to the laminator for binding operation smoothly after reaching required working temperatures. Implementing in this manner, a heating system, having high safety and enabling automatic control on the heating temperature, prior to the binding of corrugate paper raw materials really can be provided.

While the present invention has been described by preferred embodiments in conjunction with accompanying drawings, it should be understood the embodiments and the drawings are merely for descriptive and illustrative purpose, not intended for restriction of the scope of the present invention. Equivalent variations and modifications conducted by person skilled in the art without departing from the spirit and scope of the present invention should be considered to be still within the scope of the present invention.

What is claimed is:

1. A heating system prior to the binding of corrugate paper raw materials, installed in equipment line of manufacturing corrugated cardboard and implemented in the binding process of said corrugated cardboard, comprising:
at least one infrared heating device(s), having a plurality of infrared lamps, assembled on the paper feeding track(s) for conducting said binding process of paper raw materials;
at least one temperature sensor(s) assembled at one end(s) of said infrared heating device(s) for detecting respectively the temperatures of said paper raw materials heated by said infrared heating device(s); and
a laminator for conducting the binding of said paper raw materials passing through said infrared heating device(s) and said temperature sensor(s).

2. The heating system prior to the binding of corrugate paper raw materials as claimed in claim 1, wherein a flat plate body is provided over said plurality of infrared lamps of each said infrared heating device.

3. The heating system prior to binding of corrugate paper raw materials as claimed in claim 1, wherein a reflector is provided at the bottom of said plurality of infrared lamps of each said infrared heating device.
